(19) United States
(12) Patent Application Publication
(10) Pub. No.: US 2016/0032606 A1
(43) Pub. Date: Feb. 4, 2016

(54) SYSTEMS AND METHODS FOR MANUFACTURING A SUBSTANTIALLY IMPERMEABLE WALL

(71) Applicant: BECHTEL HYDROCARBON TECHNOLOGY SOLUTIONS, INC., Houston, TX (US)

(72) Inventors: Jesse Rickey Simmons, Houston, TX (US); Chris Peter John, The Woodlands, TX (US); Michael Joseph Santoro, Katy, TX (US); Richard J. Taeuber, Shanghai (CN); Robert Carl Andrews, Pasadena, TX (US); James Edward Bollweg, Houston, TX (US)

(21) Appl. No.: 14/777,467

(22) PCT Filed: Jun. 10, 2013
(86) PCT No.: PCT/US13/44980

§ 371 Date: Sep. 15, 2015

Related U.S. Application Data
(60) Provisional application No. 61/791,521, filed on Mar. 15, 2013.

(51) Int. Cl. E04H 7/18; B65G 5/00; E04B 2/84; E04H 5/02

(52) U.S. Cl. CPC E04H 7/18; E04H 5/02; B65G 5/00; E04B 2/84

(57) ABSTRACT

Systems and methods for manufacturing a substantially impermeable concrete wall that may be used, for example, in fluid storage tanks to improve leak resistance to pressurized gases or fluids and reduce manufacturing costs.

### CROSS-REFERENCE TO RELATED APPLICATIONS

The priority of U.S. Provisional Patent Application Ser. No. 61/791,521, filed on Mar. 15, 2013, is hereby claimed, and the specification thereof is incorporated herein by reference.

### STATEMENT REGARDING FEDERALLY SPONSORED RESEARCH

Not applicable.

### FIELD OF THE INVENTION

The present invention generally relates to systems and methods for manufacturing a substantially impermeable wall. More particularly, the present invention relates to manufacturing a substantially impermeable concrete wall that may be used, for example, in fluid storage tanks to improve leak resistance to pressurized gases or fluids and reduce manufacturing costs.

### BACKGROUND OF THE INVENTION

In facilities that process liquefied natural gas (LNG), the natural gas is typically cleaned of impurities and cooled thus, removing a substantial amount of thermal energy to bring it to a liquid state. In this state, it is easy to transport and store in large quantities. LNG type storage tanks are generally constructed onsite and may be used to store other fluids such as ammonia, propane, butane, ethylene, oxygen, argon, nitrogen, hydrogen, and helium, which are generally referred to as cryogenic or low temperature fluids.

Cryogenic fluid storage tanks made of reinforced or pre-stressed concrete are often lined with a metal liner to prevent gases, liquids, or other contents from moving through the concrete bottom, wall and/or roof. For the bottom, a concrete slab has a metal liner, which is simply laid on top of a concrete surface and then welded for tightness. For the tank concrete roof, a metal liner with attached anchors may be the inside formwork, resulting in an integrated roof after pouring the concrete. Various manufacturing techniques exist for constructing the wall with a metal liner, which include using a stiffened liner. This technique uses metal stiffening welded to the metal liner to resist hydraulic forces when pouring the wet concrete. A partial cross-sectional image of an exemplary prior art system 100 using metal stiffening is illustrated in FIG. 1. The system 100 includes a metal liner 107 that includes a plurality of inward facing anchors 110 that are used to secure the metal liner 107 to a concrete wall (not shown) after the wet concrete is poured between the metal liner 107 and a form 116. The form 116 includes a continuous interior surface 118 and plurality of trusses or ribs 122 that support the interior surface 118. A plurality of tie rods 112 are secured to an interior surface of the metal liner 107 at one end and are secured to the form 116 at another end by a plurality of anchor cones 113 for structural support of the system 100 when the wet concrete is poured therein. A metal stiffener comprising a plurality of vertical sections 130 and a plurality of horizontal sections 132 is used for additional structural support, which may be welded to either side of the metal liner 107 as illustrated in FIG. 1. The metal stiffener, however, is often removed and discarded after each section of the concrete wall and metal liner 107 are constructed. The metal stiffener may be removed by cutting each vertical section 130 and each horizontal section 132 where they are welded to the metal liner 107. As a result, additional material costs are incurred in addition to the expense of time spent to remove each metal stiffener from the system 100.

In order to overcome the disadvantages and delays inherent with conventional manufacturing techniques using a stiffened liner, attempts have been made to improve the manufacturing process. In U.S. Patent Application Publication No. 2008/0302804, for example, a freestanding inner steel liner is erected prior to pouring the outer concrete containment wall. Because the liner is “freestanding,” meaning that no internal or external formwork and/or stiffening is necessary, the liner is sized and configured to withstand the hydraulic forces of the concrete as the concrete wall is poured. Consequently, the liner is comprised of plates having a general thickness of more than eight millimeters. This type of cryogenic fluid storage tank can be distinguished from conventional cryogenic fluid storage tanks by the close spacing of metal rods that are required in the outer concrete wall and are attached to the liner. These metal rods are also referred to as tie rods that are used to hold the liner to the outer formwork when pouring the outer concrete wall. Because this technique is a two-step process that first requires the construction of the free standing liner followed by the construction of the outer concrete wall, construction costs may be unnecessarily high due to materials (e.g. thickness of the liner), time required for a two-step process and the inherent large volume of formwork ties that are required.

### SUMMARY OF THE INVENTION

The present invention therefore, meets the above needs and overcomes one or more deficiencies in the prior art by providing systems and methods for manufacturing a substantially impermeable concrete wall that may be used, for example, in fluid storage tanks to improve leak resistance to pressurized gases or fluids and reduce manufacturing costs.

In one embodiment, the present invention includes a system for constructing a substantially impermeable wall, which comprises: 1) a form; ii) a frame; and iii) a liner positioned between the form and the frame, the liner releasably coupled to the form and releasably connected to the frame.

In another embodiment, the present invention includes a substantially impermeable wall, which comprises: i) a stabilizing section; and ii) a liner connected to one side of the stabilizing section, the liner comprising a plurality of attachment lugs attached to an external side of the liner for releasably coupling the liner to a form and a plurality of lugs attached to an internal side of the liner for releasably connecting the liner to a frame.

In yet another embodiment, the present invention includes a method for constructing a substantially impermeable wall, which comprises pouring a stabilizing material between a form and a liner, the liner releasably coupled to the form and releasably connected to the frame.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings, in which like elements are referenced with like numerals, wherein:

FIG. 1 is a partial cross-sectional view illustrating an exemplary prior art system for constructing a cryogenic fluid storage tank.

FIG. 2 is a partial cross-sectional view illustrating one embodiment of a system for constructing a substantially impermeable wall.

FIG. 3 is an isometric view illustrating a frame for the system in FIG. 2.

FIG. 4 is a cross-sectional view illustrating a stabilizing base and reinforcing members to support the substantially impermeable wall.

FIG. 5 is a partial cross-sectional view illustrating the cross-sectional view in FIG. 4 with a liner.

FIG. 6 is a partial cross-sectional view illustrating the cross-sectional view in FIG. 4 before the system in FIG. 2 is removed from a completed section of the substantially impermeable wall.

FIG. 7 is a partial cross-sectional view illustrating the cross-sectional view in FIG. 4 after the system in FIG. 2 is removed from a completed section of the substantially impermeable wall and is repositioned as shown.

FIG. 8A is a partial cross-sectional view illustrating the application of a substantially impermeable wall in a cryogenic fluid storage tank.

FIG. 8B is an enlarged view illustrating the detail circled in FIG. 8A.

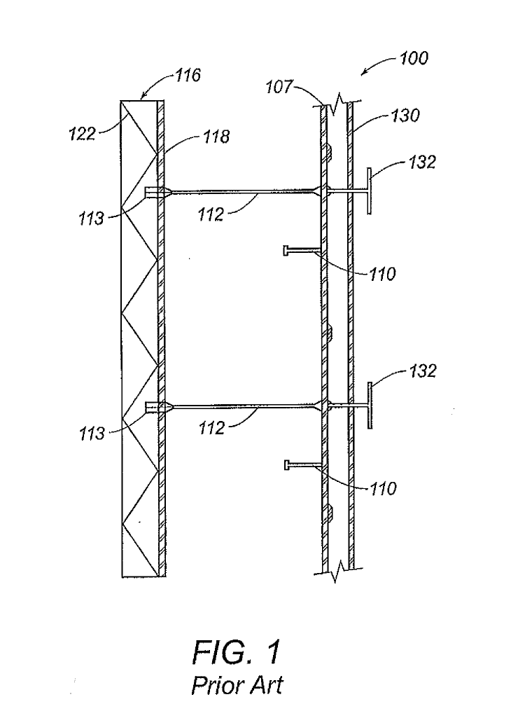

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the following description refers to storage tanks for cryogenic fluids, the systems and methods of the present invention are not limited thereto and may include other applications in which a substantially impermeable wall may be used to achieve similar results.

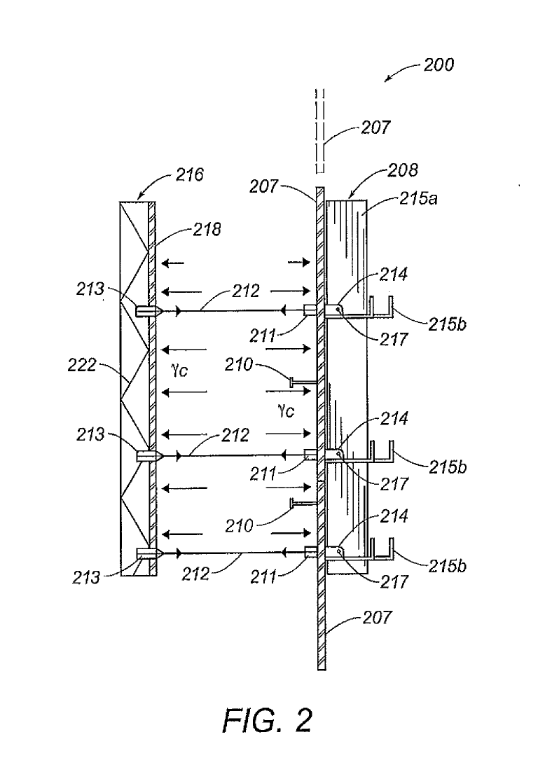

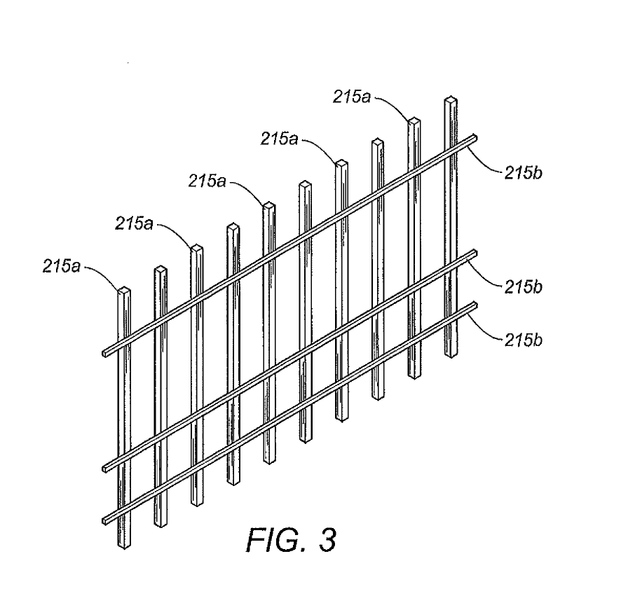

Referring now to FIG. 2, a partial cross-sectional view of one embodiment of a system 200 for constructing a substantially impermeable wall is illustrated. The system 200 includes a metal frame 208 comprising a plurality of vertical members 215a typically welded or affixed to a plurality of horizontal members 215b. The vertical members 215a may be equidistantly spaced apart relative to each other. Likewise, the horizontal members 215b may be equidistantly spaced apart relative to each other. An isometric view of an exemplary metal frame 208 is illustrated in FIG. 3, which includes horizontal members 215b that are not equidistantly spaced apart relative to each other. The vertical, members 215a and the horizontal members 215b may be attached to each other by any permanent means such as melding or they may be made from materials other than metal that meet predetermined load requirements. The metal frame 208 may also be curved.

The system 200 further includes a liner 207 that is preferably made from metal or steel, however, may be made of any other comparable composite material that resists transverse movement of fluids (i.e. substantially impermeable). The liner 207 may include one or more sections connected by a metal weld or other materials. The liner 207 also includes a plurality of attachment lugs 211 permanently attached to an external side of the liner 207 and a plurality of lugs 214 permanently attached to an internal side of the liner 207. Each of the plurality of attachment lugs 211 is positioned opposite a respective one of the plurality of lugs 214 relative to the liner 207 for the purpose of transmitting forces through the liner 207 when a force (γC) is exerted against the liner 207. The plurality of attachment lugs 211 may be permanently attached to the external side of the liner 207 by welding or any other means capable of permanently attaching the plurality of attachment lugs 211 to the external side of the liner 207. Likewise, the plurality of lugs 214 may be permanently attached to the internal side of the liner 207 by welding or any other means capable of permanently attaching the plurality of lugs 214 to the internal side of the liner 207. Each of the plurality of lugs 214 may be connected to a vertical member 215a or a horizontal member 215b in a releasable manner for releasably connecting the liner 207 to the frame. For example, each of the plurality of lugs 214 may include a respective opening 217 for receipt of a pin that passes through another opening (not shown) in the vertical member 215a or the horizontal member 215b. The liner 207 also includes a plurality of anchors 210 permanently attached to the external side of the liner 207 for connecting and integrating the liner 207 to a stabilizing section (not shown) that is preferably made of concrete.

The system 200 further includes a form 216 comprising, a plurality of trusses or ribs 222 that may be vertically and/or horizontally positioned on the continuous interior surface 218. The plurality of trusses 222 therefore, support the interior surface 218. The form 216 and the frame 208 may be constructed in sections that are substantially similar in size and shape. The materials used to construct the form 216 may include wood, metal, any composite material or a combination thereof. The interior surface 218 of the form 216, however, includes a plurality of removable form anchors 213 that include an attaching device for receipt of a metal tie rod 212. Each metal tie rod 212 therefore, is connected at one end to the plurality of attachment lugs 211 and is connected at another end to the plurality of form anchors 213. Each metal tie rod 212 may be protected by a sleeve so that each metal tie rod 212 may be removed and reused after each section of the substantially impermeable wall is completed. In this manner, the liner 207 may be releasably coupled to the form 216 to resist a force (γC ) exerted against the liner 207 by concrete or any other material poured between the liner 207 and the form 216. The interior surface 218 of the form 216 therefore, is preferably made of any material capable of withstanding the force (γC) exerted against the liner 207 to transfer the tension load into the plurality of metal tie rods 212, attachment lugs 211, lugs 214 and form anchors 213. On the inside surface of the concrete stabilizing section, the lateral force (γC) is transferred through the liner 207 into the frame 208 that in turn places the plurality of attachment lugs 211, metal tie rods 212, form anchors 213 and lugs 214 into tension and balances the load.

Although the substantially impermeable wall may comprise a concrete section (not shown) that exerts the force (γC) illustrated in FIG. 2, it may comprise a similar section made from different materials for stabilizing the substantially impermeable wall. The substantially impermeable wall therefore, may comprise a stabilizing section made of concrete and the liner 207. The liner 207 is connected to a side of the stabilizing section by the plurality of anchors 210. Once a section of the substantially impermeable wall is completed using the system 200, liner 207 remains connected to the stabilizing section by the plurality of anchors 210 and the plurality of attachment lugs 211 that are embedded in the stabilizing section. The plurality of metal tie rods 212, the plurality of form anchors 213 and the form 216 may be removed and reused. Likewise, the frame 208 may be removed and reused. The plurality of lugs 214 may be optionally removed by cutting them from the external surface of the liner 207. If each of the plurality of the metal tie rods 212 are positioned through a protective sleeve, they may be removed after the form 216 is removed leaving the plurality of form anchors 213 to be removed with the plurality of metal tie rods 212 as each metal tie rod 212 is disconnected from a respective one of the plurality of attachment lugs 211. The form 216 and the frame 208 therefore, may be used for construction of another section of the substantially impermeable wall.

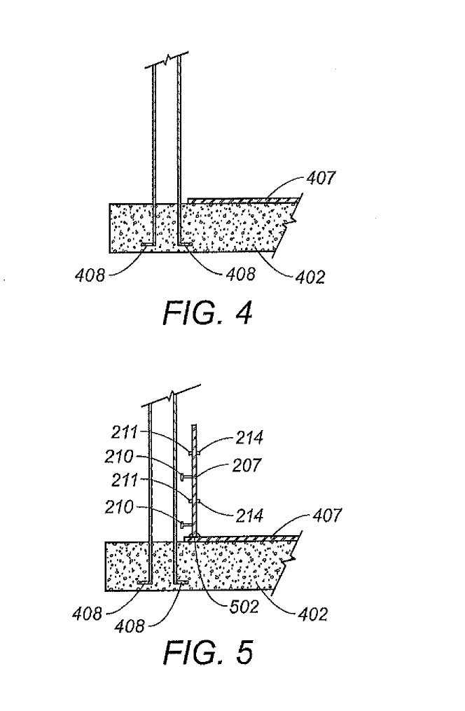

Referring now to FIGS. 4-7, a method for manufacturing a substantially impermeable wall is illustrated.

In FIG. 4, a cross-sectional view of a stabilizing base 402 and reinforcing members 408 is illustrated. The stabilizing base 402 may be made of concrete or any other material in which the reinforcing members 408 may be positioned and secured for construction of the substantially impermeable wall. The reinforcing members 408 may be rebar or any other rigid material that may be used to reinforce and support the substantially impermeable wall. The reinforcing members 408 are therefore, optional as well as a liner base 407 that may be used to cover the stabilizing base 402 to form a substantially impermeable base within an enclosure formed by the fully constructed substantially impermeable wall for containing fluids. The liner base 407 therefore, may be made of any substantially impermeable material such as, for example, metal or steel.

In FIG. 5, a partial cross-sectional view of FIG. 4 is illustrated with the liner 207 that includes a plurality of anchors 210, attachment lugs 211 and lugs 214. The liner 207 is preferably welded to the liner base 407 at weld 502 and forms a substantially impermeable seal in the event that the substantially impermeable wall is intended to extend to the liner base 407 for purposes of containing fluids.

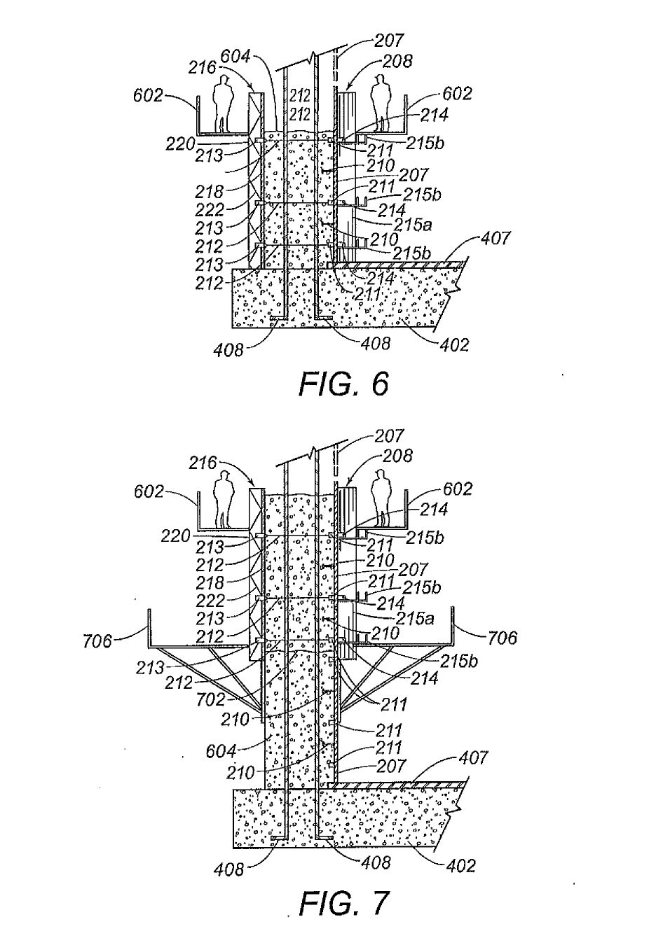

In FIG. 6, a partial cross-sectional view of FIG. 4 is illustrated before the system 200 is removed from a completed section of the substantially impermeable wall. The system 200 remains in place while a stabilizing section 604 hardens, which is preferably concrete. Scaffolding 602 may be attached to the form 216 and frame 208 for securing another section of the liner 207 and constructing another section of the substantially impermeable wall above the previously constructed section using the system 200.

In FIG. 7, a partial cross-sectional view of FIG. 4 is illustrated after the system 200 is removed from a completed section of the substantially impermeable wall and is repositioned as shown. Here, the system 200 is removed from the stabilizing section 604 in FIG. 6 and is repositioned to construct another stabilizing section. As demonstrated by the stabilizing section 604 and the liner 207, another stabilizing section may be constructed on top of the stabilizing section 604 wherein additional scaffolding 706 may be used for removing the plurality of form anchors 213 as the system 200 is removed and moved upward to construct another stabilizing section. The scaffolding 602 may be used to position another section of the liner 207 shown as a dashed line and then weld it to the liner 207, which is currently connected to the another stabilizing section before the system 200 is removed with scaffolding 602 and is repositioned to construct the next section of the substantially impermeable wall. Construction joints 702 therefore, exist between each stabilizing section of the substantially impermeable wall. If a third stabilizing section is needed, bottom scaffolding (not shown) may be positioned around the stabilizing section 604 for removing the plurality of lugs 214 while the scaffolding 602 and additional scaffolding 706 are repositioned for construction of the next stabilizing section and removing the plurality of form anchors 213, respectively.

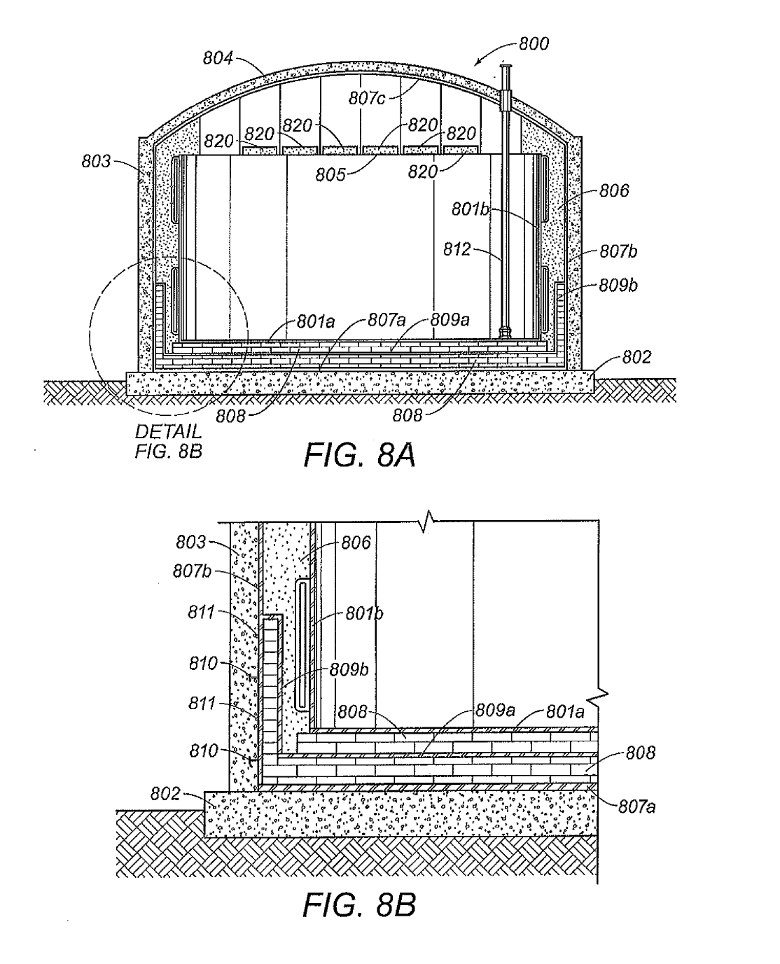

Referring now to FIG. 8A, a partial cross-sectional view of a substantially impermeable wall in a cryogenic fluid storage tank is illustrated. The storage tank 800 includes an inner tank comprising an inner tank bottom 801a and an inner tank wall 801b, preferably made of metal. A concrete slab 802 forms the base of the storage tank 800, which supports the inner tank and other components. A concrete wall 803 partially encloses the storage tank 800, with the concrete wall 803 being positioned near a perimeter of the concrete slab and may be cylindrical, square or any other shape practical for the for storing cryogenic fluids. A roof 804, preferably made of concrete, is formed with a perimeter that joins a top of the concrete wall 803 for enclosing the storage tank 800. A deck 805 is suspended from a ceiling in the storage tank 800 for supporting a plurality of insulation 820. Additional insulation 806 is used around the inner tank wall 801b. A substantially impermeable metal liner is positioned against the concrete slab 802, the concrete wall 803 and the roof 804, which includes a metal bottom liner 807a, a metal side liner 807b and a metal roof liner 807c. The substantially impermeable metal liner is used to prevent the transmission of fluids into and out of the storage tank 800. Bottom support pads 808 include block insulation for supporting the inner tank. A thermal corner protection section includes a metal bottom 809a and a metal wall 809b. The metal bottom 809a is positioned below the inner tank and between the inner tank bottom 801a and the metal bottom liner 807a. The metal wall 809b is similarly positioned between the inner tank wall 801b and the metal side liner 807b. The metal bottom 809a is therefore, connected to the metal wall 809b, which is connected to the metal side liner 807b. It should be understood by one of ordinary skill in the art, that an inner tank and thermal corner protection section may or may not be included in the design of storage tank 800, where a substantially impermeable wall is manufactured and employed.

Referring now to FIG. 8B, an enlarged view of the details circled in FIG. 8A is illustrated. The metal side liner 807b and the concrete wall 803 are constructed using the system in FIG. 2 to form a substantially impermeable wall. Once the system in FIG. 2 is removed, the substantially impermeable wall includes a stabilizing section comprising the concrete wall 803 and the substantially impermeable metal liner, which includes the metal side liner 807b, a plurality of attachment lugs 811 for releasably coupling the metal side liner 807b to a form and a plurality of concrete anchors 810 for securing the metal side liner 807b to the concrete wall 803.

The systems and methods of the present invention therefore, allow for integration of a metal liner and frame as each section of the concrete wall is constructed in one step, without the need for excessive metal liner thickness, excessive metal tie rods or conventional stiffening welded to the liner.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A system for constructing a substantially impermeable wall, which comprises:
a form;
a frame; and
a liner positioned between the form and the frame, the liner releasably coupled to the form and releasably connected to the frame.

2. The system of claim 1, wherein the liner is substantially impermeable.

3. The system of claim 1, wherein the liner includes a plurality of attachment lugs permanently attached to an external side of the liner and a plurality of lugs permanently attached to an internal side of the liner.

4. The system of claim 3, wherein each of the plurality of attachment lugs is positioned opposite a respective one of the plurality of lugs relative to the liner for transmitting forces through the liner into the frame when a force is exerted against the liner.

5. The system of claim 3, wherein each of the plurality of attachment lugs is welded to the external side of the liner and each of the plurality of lugs is welded to the internal side of the liner.

6. The system of claim 3, wherein each of the plurality of lugs is releasably connected to the frame.

7. The system of claim 1, wherein each of the plurality of attachment lugs is releasably coupled to the form.

8. The system of claim 1, wherein the liner includes a plurality of anchors permanently attached to an external side of the liner.

9. A substantially impermeable wall, which comprises:
a stabilizing section; and
a liner connected to one side of the stabilizing section, the liner comprising a plurality of attachment lugs attached to an external side of the liner for releasably coupling the liner to a form and a plurality of lugs attached to an internal side of the liner for releasably connecting the liner to a frame.

10. The wall of claim 9, wherein the liner is substantially impermeable.

11. The wall of claim 9, wherein each of the plurality of attachment lugs is positioned opposite a respective one of the plurality of lugs relative to the liner for transmitting forces through the liner into the frame when a force is exerted against the liner.

12. The wall of claim 9, wherein each of the plurality of attachment lugs is welded to the external side of the liner and each of the plurality of lugs is welded to the internal side of the liner.

13. The wall of claim 9, wherein the liner includes a plurality of anchors permanently attached to an external side of the liner.

14. The wall of claim 13, wherein the liner is connected to the one side of the stabilizing section by the plurality of anchors.

15. A method for constructing a substantially impermeable wall, which comprises pouring a stabilizing material between a form and a liner, the liner releasably coupled to the form and releasably connected to the frame.

16. The method of claim 15, wherein the stabilizing material is concrete.

17. The method of claim 15, wherein the stabilizing material is poured for a section of the substantially impermeable wall.

18. The method of claim 15, wherein the liner is substantially impermeable and has a thickness of less than eight millimeters.

19. The method of claim 17, further comprising removing the form and the frame after completing the section of the substantially impermeable wall.

20. The method of claim 19, further comprising pouring the stabilizing material between the form and another liner for another section of the substantially impermeable wall, the another liner releasably coupled to the form and releasably connected to the frame.
